(19) United States
(12) Patent Application Publication
(10) Pub. No.: US 2012/0203491 A1
(43) Pub. Date: Aug. 9, 2012

(54) METHOD AND APPARATUS FOR PROVIDING CONTEXT-AWARE CONTROL OF SENSORS AND SENSOR DATA

(75) Inventors: Feng-Tso Sun, Palo Alto, CA (US); Cynthia Kuo, Mountain View, CA (US); Raja Bose, Mountain View, CA (US)

(73) Assignee: Nokia Corporation, Espoo (FI)

(21) Appl. No.: 13/020,631

(22) Filed: Feb. 3, 2011

(51) Int. Cl. G06F 19/00

(52) U.S. Cl. 702/108

(57) ABSTRACT

An approach is provided for context-aware control of sensors and sensor data. A sensor manager determines context information based, at least in part, on one or more sensors. The sensor manager also determines resource consumption information associated with a one or more other sensors, one or more functions of the one or more other sensors, or a combination thereof. The sensor manager then processes and/or facilitates a processing of the context information and the resource consumption information to determine at least one operational state associated with the one or more other sensors, the one or more functions of the one or more other sensors, or a combination thereof.

### BACKGROUND

Service providers (e.g., wireless, cellular, etc.) and device manufacturers are continually challenged to deliver value and convenience to consumers by, for example, providing compelling network services. One area of development has been the integration of sensors for determining contextual information for use in network services to enable such services to be, for instance, context-aware. For example, context-aware systems use knowledge about a user's current situation to tailor system services, functions, content, etc. in a situationally-appropriate manner based on data collected from one or more sensors. These sensors may include health and wellness sensors such as electrocardiograph (ECG) sensors, photoplethysmograph (PPG) sensors, galvanic skin response (GSR) sensors, and the like. As use of such sensors become more common, service providers and device manufacturers face significant challenges to enabling the sensors to operate continuously for prolonged periods, particularly when the sensors operate on limited battery power.

### SOME EXAMPLE EMBODIMENTS

Therefore, there is a need for an approach for providing context-aware control of sensors and sensor data while maximizing, for instance, energy efficiency and data quality.

According to one embodiment, a method comprises determining context information based, at least in part, on one or more sensors. The method also comprises determining resource consumption information associated with one or more other sensors, one or more functions of the one or more other sensors, or a combination thereof. The method further comprises processing and/or facilitating a processing of the context information and the resource consumption information to determine at least one operational state associated with the one or more other sensors, the one or more functions of the one or more other sensors, or a combination thereof.

According to another embodiment, an apparatus comprising at least one processor, and at least one memory including computer program code, the at least one memory and the computer program code configured to, with the at least one processor, cause, at least in part, the apparatus to determine context information based, at least in part, on one or more sensors. The apparatus is also caused to determine resource consumption information associated with one or more other sensors, one or more functions of the one or more other sensors, or a combination thereof. The apparatus is further caused to process and/or facilitate a processing of the context information and the resource consumption information to determine at least one operational state associated with the one or more other sensors, the one or more functions of the one or more other sensors, or a combination thereof.

According to another embodiment, a computer-readable storage medium carrying one or more sequences of one or more instructions which, when executed by one or more processors, cause, at least in part, an apparatus to determine context information based, at least in part, on one or more sensors. The apparatus is also caused to determine resource consumption information associated with one or more other sensors, one or more functions of the one or more other sensors, or a combination thereof. The apparatus is further caused to process and/or facilitate a processing of the context information and the resource consumption information to determine at least one operational state associated with the one or more other sensors, the one or more functions of the one or more other sensors, or a combination thereof.

According to another embodiment, an apparatus comprises means for determining context information based, at least in part, on one or more sensors. The apparatus also comprises means for determining resource consumption information associated with one or more other sensors, one or more functions of the one or more other sensors, or a combination thereof. The apparatus further comprises means for processing and/or facilitating a processing of the context information and the resource consumption information to determine at least one operational state associated with the one or more other sensors, the one or more functions of the one or more other sensors, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing context-aware control of sensors and sensor data, according to one embodiment;

FIG. 2 is a diagram of the components of a sensor manager, according to one embodiment;

FIG. 3 is a flowchart of a process for providing context-aware control of sensor data, according to one embodiment;

FIG. 4A is a diagram of a framework for context-aware control of health and wellness sensors, according to one embodiment;

FIG. 4B is a flowchart of a process for context-aware control of health and wellness sensors, according to once embodiment;

FIGS. 5A-5C are diagrams of a process for context-aware control of sensors and sensor data wherein a device acts as a master of the process, according to various embodiments;

FIGS. 6A-6C are diagrams of a process for context-aware control of sensors and sensor data wherein a sensor acts as a master of the process, according to various embodiments;

FIG. 7 is a diagram of a user interface utilized in the processes of FIGS. 1-6C, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for providing context-aware control of sensors and sensor data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are discussed with respect to health and wellness sensors, it is contemplated that embodiments of the approach described herein are applicable to any type of sensor including environmental sensors, sensors for physical properties, material sensors, location sensors, etc.

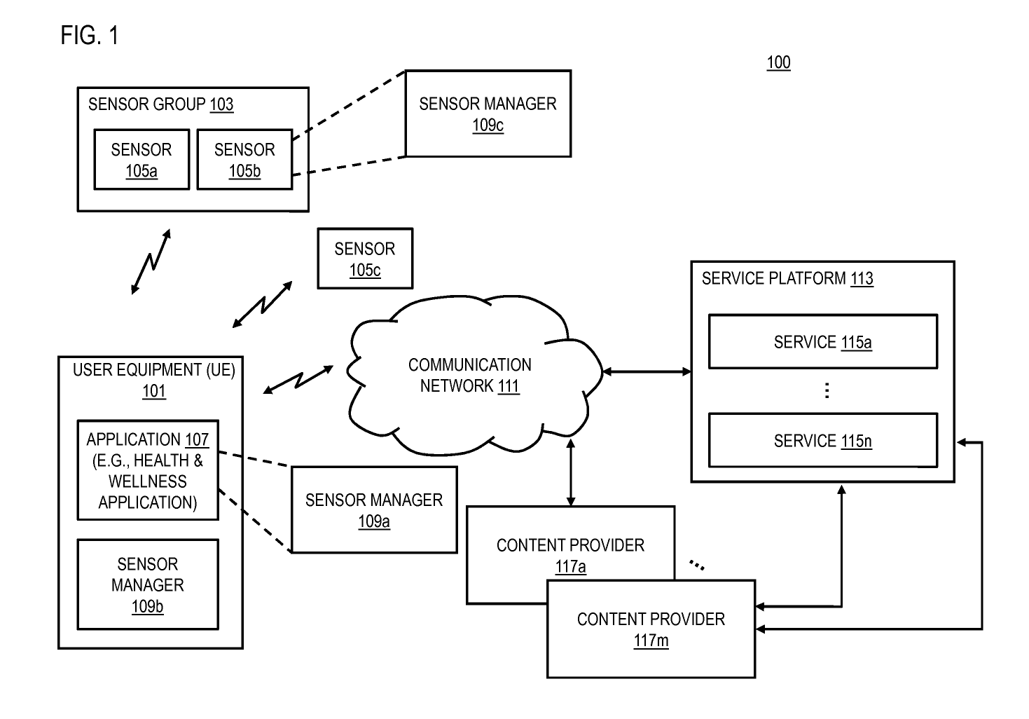

FIG. 1 is a diagram of a system capable of providing context-aware control of sensor and sensor data, according to one embodiment. As discussed above, the contextual awareness of a system or service is often based on sensor data. For example, possible sensors that may be associated with devices (e.g., mobile devices such as cell phones, smartphones, etc.) include location sensors (e.g., Global Positioning System (GPS) sensors, light sensors, proximity sensors, accelerometers, gyroscopes, etc.).

Within the context of systems for supporting health and wellness services and/or applications, possible sensors include electrocardiograph (ECG) sensors, photoplethysmograph (PPG) sensors, galvanic skin response (GSR) sensors, electroencephalograph (EEG) sensors, electromyography (EMG) sensors, and the like. In one embodiment, the health and wellness sensors support body sensor network (BSN) technologies that offer opportunities for monitoring physiological signals with wearable sensors in a mobile environment. For example, ECG-based wearable sensors enable continuous or substantially continuous monitoring for emotion monitoring and/or monitoring for cardiovascular disease.

In one embodiment, such monitoring is used to support pervasive healthcare which has drawn the attention in research communities such as ubiquitous computing, bio-engineering, and medical informatics because of the potential for the monitoring to provide longitudinal and quantitative personal data collection. The reliability and continuous nature of such monitoring is one key element in a program to maintain user wellness. As noted, a main component to support pervasive healthcare is a BSN system. In one embodiment, a BSN system includes use of wireless sensor nodes with smaller size, longer battery life, and powerful computing capabilities.

However, the operating lifetime of the physiological sensor is a key challenge in continuous monitoring design. More specifically, sensors may potentially require a significant amount of battery power (relative to the capacity of a battery on a small device) to operate continuously. Accordingly, extending and optimizing battery life (e.g., reducing energy consumption) is a significant challenge for service providers and device manufacturers. In other words, in order to offer the continuous monitoring and real-time or substantially real-time collection and analysis of sensor data, the BSN and its sensors need sufficient efficiency with respect to energy consumption to sense, transmit, and/or process the sensor data stream. For example, a wearable ECG sensor for stress detection cannot function effectively if battery life is limited to only a few hours. In particular, limited battery life and/or inefficient use of available energy reserves (e.g., battery life) can be further exacerbated with high data rate physiological sensors or high use of wireless transceivers to transmit the data from the sensors. In other cases, reducing energy consumption by the sensors also enables design of smaller, lighter, and more wearable sensor designs.

To address these problems, a system 100 of FIG. 1 introduces the capability of using context information (e.g., sensor data) detected or otherwise collected at one or more sensors to determine an operational state of one or more other sensors (e.g., health and wellness sensors) or one or more functions of the one or more other sensors. As used herein, an operational state refers to an operating condition (e.g., enabled or disabled), one or more operating parameters (e.g., sampling rate, sampling start or end, sampling parameters, etc.). In one embodiment, the operational state is determined to reduce resource consumption (e.g., energy consumption, bandwidth consumption, processing consumption, etc.) by the one or more other sensors. In this way, resources can be conserved to prolong the operational life or time of the sensors before one or more of the resources has to be replenished (e.g., recharging or replacing a sensor's battery).

In one embodiment, the one or more functions can be related to, for instance, on-node data collection, data processing, data transmission, and related operations. For example, depending on the context information and information on energy consumption or availability, one or more of the functions can be performed at the sensor itself, transmitted to an associated device (e.g., a mobile device) for processing, transmitted to a related service (e.g., a backend service) for processing, or some combination. In one embodiment, the determination of whether to perform on-node (e.g., on sensor) functions can be based, at least in part, on a comparison of the energy costs associated with performing the function at the node versus the energy costs associated with transmitting the data to another device or service for processing. In most cases, the energy or resource costs of transmitting usually outweigh the resource burden of on-node processing. Accordingly, the system 100 can exploit the on-node processing capabilities of a sensor to reduce over resource or energy consumption and prolong the operational life of the sensor.

In one embodiment, in the context of health and wellness sensors (e.g., a wearable ECG sensor), the system 100 can determine context, information at another sensor or sensors (e.g., an accelerometer, gyroscope, compass, etc.) to determine when to enable or disable one or more of the health and wellness sensors (e.g., an ECG sensor) and/or their functions to conserve resources. For example, many health and wealth sensors measure physiological characteristics of a user. Historically, these measurements have not been accurate if the measurement is taken with the user is moving or engage in some level of physical activity. Accordingly, in one embodiment, the system 100 uses an individual's physical activity level to boost the accuracy of sensor data interpretation as well as to reduce energy consumption by turning the physiological sensor off or other restricting its functions under conditions (e.g., high levels of movement) when the collected data would not be accurate.

For example, assuming the user is wearing a first sensor or group of sensors that capture acceleration and a second sensor or group of sensors that capture physiological data such as heart rate signals, the system 100 determines the user's physical activity using the accelerometer data. In one embodiment, the physical activity level is categorized in descriptive terms such as “low,” “medium,” and “high.” In addition or alternatively, the physical activity level can be described using a numerical metric or other ordinal scale. In either case, during vigorous physical activity, physiological sensor data can be unreliable, as the activity introduces motion artifacts. Thus, under this context (e.g., high physical activity), the system 100 stops collecting and/or processing data at the physiological sensor or sensors while the user is active. Using the context information collected at the first sensor or group of sensors (e.g., the accelerometer data) to stop data collection and/or processing at the second sensor or group of sensors enables the system 100 to: (1) save resources (e.g., battery life of the sensor), and (2) increase the accuracy of the sensor data analysis by avoiding collecting data when artifacts can reduce the quality of the data.

As shown in FIG. 1, the system 100 includes a user equipment (UE) 101 with connectivity to at least one sensor group 103 including sensors 105a (e.g., a first sensor) and 105b (e.g., a second sensor). In one embodiment, the sensor group 103 constitutes a wearable sensor in which multiple sensors (e.g., sensors 105a and 105b) are included to provide additional functionality. For example, as described above, the sensor group 103 may include a combination of an accelerometer (e.g., sensor 105a) and a physiological sensor (e.g., sensor 105b) such as an ECG sensor. As shown, the UE 101 also has connectivity to a standalone sensor 105c that can operate independently or in coordination with the sensor group 103 or other sensor groups or sensors. In one embodiment, the sensor group 103 and or the sensors 105a-105c (also collectively referred to as sensors 105) may comprise a BSN. By way of example, connectivity between the UE 101 and the sensor group 103 and the sensors 105a-105c can be facilitated by short range wireless communications (e.g., Bluetooth, Wi-Fi, ANT/ANT+, ZigBee, etc.).

In addition, the UE 101 can execute an application 107 that is a software client for storing, processing, and/or forwarding the sensor data to other components of the system 100. In one embodiment, the application 107 may include a sensor manager 109a for performing functions related to providing context-aware control of the sensor group 103 and/or the sensors 105a-105c as discussed with respect to the various embodiments of the approach described herein. In addition or alternatively, it is contemplated that the UE 101 may include a standalone sensor manager 109b that operates independently of the application 107, and that the sensors themselves may include a sensor manager 109c (e.g., as shown with respect to sensor 105b).

As shown in FIG. 1, the UE 101 has connectivity via a communication network 111 to a service platform 113 which includes one or more services 115a-115n (also collectively referred to as services 115) (e.g., health and wellness service or any other service that can use contextually aware sensor information), the one or more content providers 117a-117m (also collectively referred to as content providers 117) (e.g., online content retailers, public databases, etc.). In one embodiment, the sensors 105a-105c, the sensor managers 109a-109c (also collectively referred to as sensor managers 109), and or the application 107 can transmit sensor data to the service platform 113, the services 115a-115n, and/or the content providers 117a-117m for storage, processing, and/or further transmission.

In one sample use case, a user wears the sensor group 103 and/or the sensors 105a-105c for continuous monitoring and collection of sensor data (e.g., for continuous ECG monitoring). For such ECG monitoring, in an ideal case, the user wearing a sensor is stationary when a measurement is taken to reduce potential movement artifacts in the data. For example, the sensor group 103 transmits accelerometer and ECG information to the UE 101 at periodic intervals. The UE 101 (e.g., via the application 107 and/or the sensor manager 109b) stores the data temporarily, performs any needed processing and aggregation, and sends the data to one or more of the services 115 at periodic intervals. In one embodiment, the data sent includes, at least in part, timestamps, sensor data (e.g., physiological data), and/or context information (e.g., activity level determined from the accelerometer data).

When the context information (e.g., accelerometer data) indicates movement of the sensor group 103 and/or movement of the user wearing the sensor group 103 above a predetermined threshold, the sensor manager 109 will, for instance: (1) turn off the sensor 105 collecting the data; (2) transmit an indicator that activity levels are high and that no data will be collected; and/or (3) log or store the activity levels in the sensor manager 109's memory such as a flash memory of the sensor 105. This decreases the amount of data transferred to the UE 101 and to the corresponding service 115, thereby extending both the sensor 105's and the UE 101's operational capacities (e.g., battery lives) while also removing potentially noisy data (e.g. motion artifacts) from the data set. In one embodiment, the sensor manager 109 process the context information to recognize simple and/or coarse-grained daily activities (e.g., sitting, standing, walking, etc.) to optimize the energy consumption of the sensors 105.

It is noted that although various embodiments discuss context information as motion or movement information, it is contemplated that the context information may relate to any operational parameter corresponding to the sensor 105 that is performing the data collection. For example, if the data collecting sensor 105 is an ECG sensor, the context information may also include parameters related to oxygenation levels in the blood, heart rate, galvanic skin response, or a combination of the parameters.

By way of example, the communication network 111 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the sensor group 103, the sensors 105, the application 107, and service platform 113 communicate with each other and other components of the communication network 111 using well known, new or still developing protocols. In this context, a protocol includes a set of rules defining how the network nodes within the communication network 111 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the application 107 and the service platform 113 may interact according to a client-server model. According to the client-server model, a client process sends a message including a request to a server process, and the server process responds by providing a service (e.g., providing map information). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

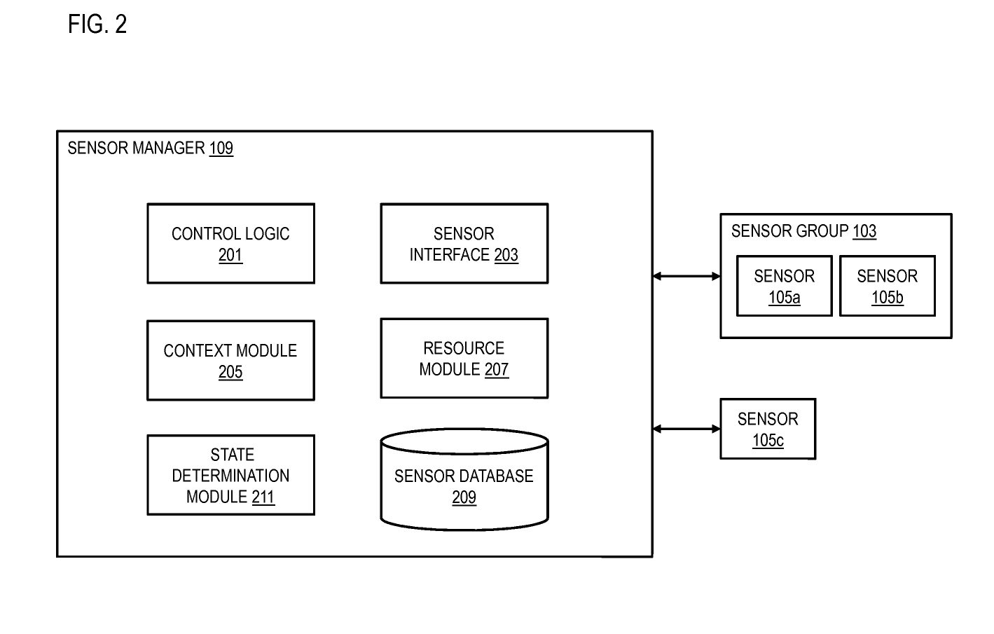

FIG. 2 is a diagram of the components of a sensor manager, according to one embodiment. By way of example, the sensor manager 109 includes one or more components for providing context-aware control of sensors and sensor data. It is contemplated that the functions of these components may be combined in one or more components or performed by other components of equivalent functionality. In this embodiment, the sensor module 109 includes at least a control logic 201 which executes at least one algorithm for executing functions of the sensor manager 109. In one embodiment, the control logic 201 interacts with a sensor interface 203 to receive or otherwise detect context information and/or data collected by one or more sensors 105. In one embodiment, the sensor interface is based on short range radio technology (e.g., Bluetooth, Wi-Fi, ANT/ANT+, ZigBee, etc.).

The context module 205 receives, stores, and/or processes the context information received via the sensor interface 203. By way of example, the context module 205 processes the context information to determine one or more operational parameters of the sensor 105 that is to collect data. In one embodiment, the context module 205 can extract the operational parameters or other features from context information or context information stream. By way of example, features may be extracted according to time and/or frequency domains of the features that can distinguish activity levels and/or identify the specific activities (e.g., walking, sitting, running, etc.). In some embodiments, where resources (e.g., processing resources or power) are limited (e.g., in the sensor 105 or the UE 101), just the time domain may be investigated. Under this scenario, a feature vector is calculated within a predetermined time window (e.g., five seconds) with a certain overlap between the windows (e.g., 50% overlap).

In one embodiment, the context module 205 use the following acceleration features to train a context information classifier:
Average: mean value of the acceleration signal for each axis in the window.
Variance: variance of the acceleration signal for each axis in the window.
Signal Magnitude Area (SMA): SMA has been regarded as a suitable feature for discriminate activity intensity. SMA is calculated by

$$S M A = \frac{1}{w} {\sum }_{i = 1}^{w} \vert x ( i ) \vert + \vert y ( i ) \vert + \vert z ( i ) \vert$$

where x(i), and z(i) are the acceleration signals along x axis, y axis, and z axis respectively.
Correlation between each pair of axes: The correlation of a pair of axes is calculated by dividing covariance of two axes of acceleration signals in the window by the product of their standard variance. For example, the correlation of x and y axes is formulated by

$$correlation ( X , Y ) = \frac{covariance ( X , Y )}{{σ}_{X} {σ}_{Y}}$$

The correlation between axes can be used to differentiate the orientation of the sensor.

In another embodiment, to further compensate for the limited processing resource of the sensor 105 and/or the UE 101, the context module 205 implements a lightweight classification scheme for classifying the context information. By way of example, the lightweight classification scheme is a decision tree. More specifically, during the learning stage, the tree structure is constructed. For example, during the learning stage, participating subjects are instructed to perform various activities (e.g., sitting, standing, walking, etc.) while accelerometers attached to the subjects are sampled to determine the profile for each activity for incorporation into the tree. In one embodiment, the tree structure has decision nodes and classification leaves. For example the decision nodes represent the test conditions while the leaves represent the classification result.

In tandem with the context module 205, the resource module 207 can monitor or determine resource consumption associated with collecting, processing, transmitting, etc. of the sensor data. The results of the monitoring and/or data collection can be stored in the sensor database 209. For example, if the resource is battery life, the resource module 207 can determine the energy consumption associated with one or more functions of the sensor 105. For example, the resource module 207 can generate energy models and/or profiles to describe the energy consumption of the sensor 105. More specifically, in a general BSN system, the sensors 105 are used for sensing physiological signals and directly transmitting to a base station or to a piece of user equipment. The basic operations that consume power are sampling and radio transmission. Therefore, a generic energy model can be formulated as:

Energy( )=Sample( )+Transmission( )

The energy consumption of sampling depends on the number, sampling frequency, and the duty-cycle of the actuators enabled on the sensor 105. The energy consumption of radio transmission usually dominates the most of power of the sensor 105 and consists of two parts. The first part is the energy the radio module consumes when it is in power-on state. Another part is the energy to transmit the packet generated by the sensor. The radio power consumption usually dominates the whole power consumption in a BSN system.

In another embodiment, the resource module 207 can create an activity-based energy model. For example, with respect to an ECG-based application, the peak interval of the ECG (e.g., RR interval) is the basic element for analysis (e.g., emotion recognition or arrhythmia detection). Furthermore, the ECG-based application usually discards the RR interval data segments while the user's physical activity level is not relatively at rest.

As noted previously, radio transmission is generally expensive in terms of power consumption. Accordingly, one goal of the system 100 is to find maximum energy conservation without sacrificing real-time or substantially real-time processing. Accordingly, the resource module 207 can implement on-node RR interval processing to reduce the amount of data to transmit while still providing relevant RR intervals to the data to the ECG-based application for processing. The resource module 207 can also exploit the context information to control the radio operation state to optimize the duty cycle for the desired ECG data.

The state determination module 209 can then determine the operational states of the sensors 105 based on the context information and resource consumption information stored in the sensor database 105. For example, in the context of a health and wellness application 107, the application 107 usually transmits the sensed data in real-time ore near-time directly back to the base station (e.g., PC or mobile device). However, the traditional approach likely runs out the battery life within hours due to the always-on radio usage and high data transmission rate.

Many continuous monitoring applications require the extracted features rather than raw data as input for a sophisticated analysis. For example, the heart rate variability analysis for emotion recognition or cardiac arrhythmia detection uses the RR interval extracted from ECG raw data as the basic element. Also, the ECG-based application usually excludes the ECG data segment under high activity intensity condition.

Therefore, the state determination module 211 uses an energy optimization algorithm that takes the advantage of exploiting on-node processing and filtering unnecessary sensed data segments by using activity context during run-time for energy efficiency. In one embodiment, the proposed energy optimization algorithm's effectiveness depends on dynamic adjustment of the radio usage and the sampling frequency of accelerometer. Also, the on-node RR extraction reduces the amount of data to transmit over the radio communication. The algorithm also illustrates that the sensor 105 continues transmitting the activity recognition result and the extracted RR interval information to the mobile phone while the activity is classified as relatively low intensity (e.g., sitting or standing). Otherwise, while the user's activity intensity is higher than walking, the sensor shuts down its radio and save the extracted features into local flash memory.

In one embodiment, the sampling frequency is controlled by a repeated timer. Hence, by default, the accelerometer's sampling frequency is the same as ECG sensor at 100 Hz, though in some cases the acceleration data is downsampled to 5 Hz, In another embodiment, the system can be configured not to trace the ECG signals during high activity period. Therefore, the accelerometer may be dynamically changed to lower sampling frequency for monitoring the transition of the user's activity only with lower sampling power consumption.

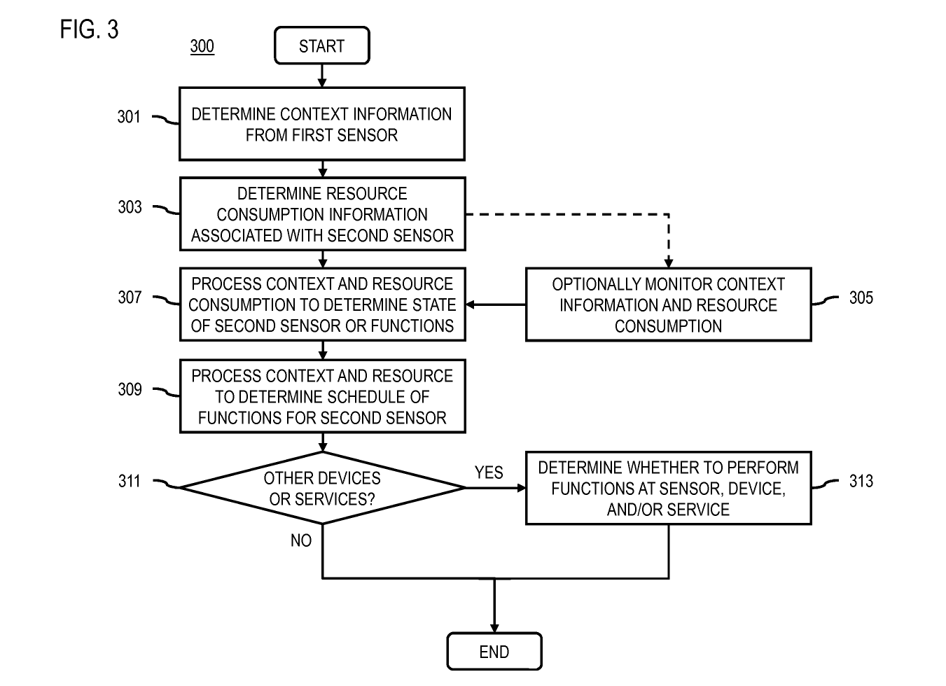

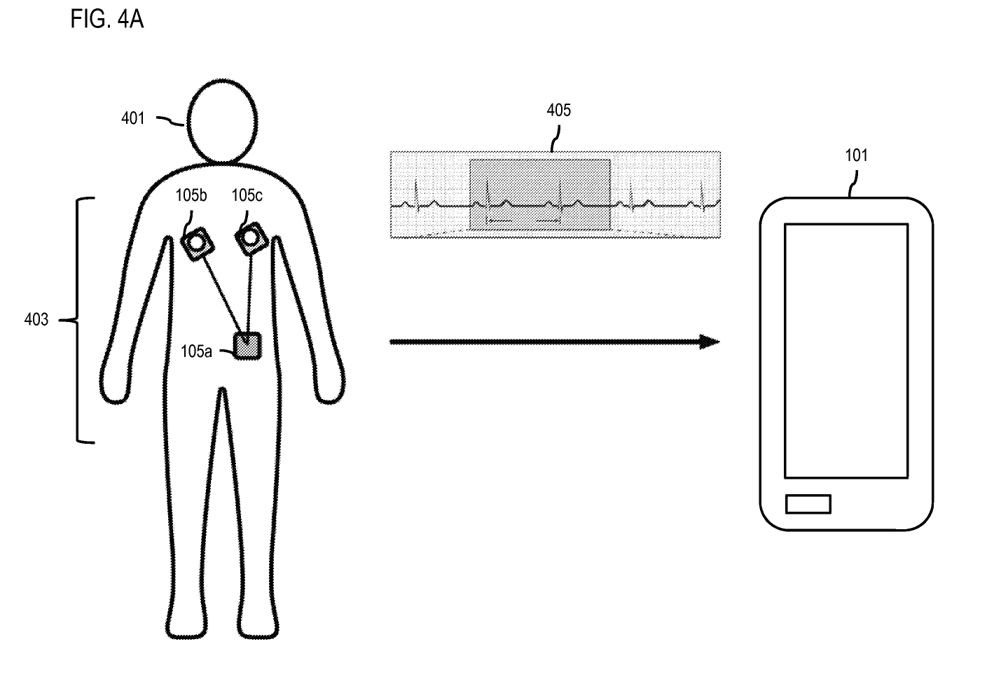

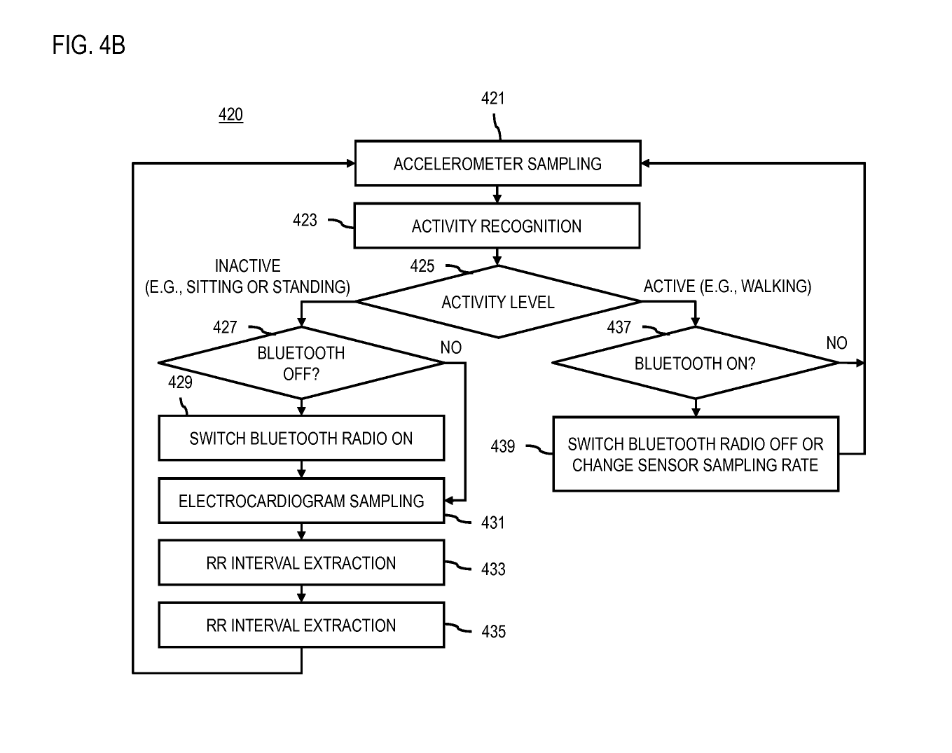

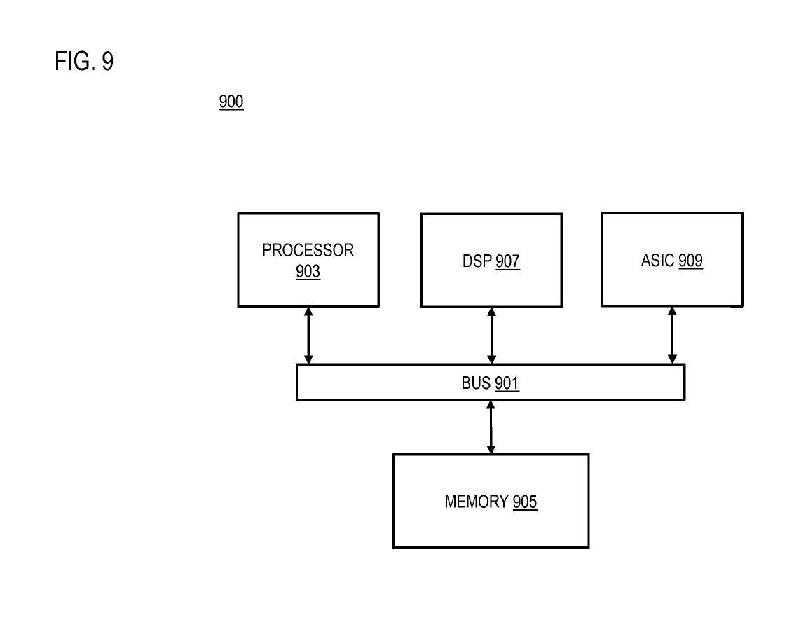

FIG. 3 is a flowchart of a process for providing context-aware control of sensor data, according to one embodiment. In one embodiment, the sensor manager 109 performs the process 300 and is implemented in, for instance, a chip set including a processor and a memory as shown FIG. 9. The process 300 provides a general overall process for providing context-aware control of sensors and sensor data that is discussed in more detail with respect to FIGS. 4A-7 below. In step 301, the sensor manager 109 determines context information based, at least in part, on a first sensor 105 (e.g., an accelerometer). In one embodiment, the context information is further based, at least in part, on at least a third sensor 105, one or more other sensors 105 or a combination thereof. It is contemplated that the first sensor 105, the third sensor 105, and/or other sensors 105 may provide context information related to one or more operational parameters of the second sensor 105 and/or one or more functions of the second sensor 105. In one embodiment, the second sensor 105 is a wearable health or wellness sensor. In yet another embodiment, the second sensor 105 (e.g., a physiological sensor) is affected by movement, and the first sensor 105 (e.g., an accelerometer) detects at least one movement or one or more characteristics of the at least one movement of the second sensor. Similar to the first sensor 105, the second sensor can be associated with one or more other sensors 105 that are responsible for collecting a set of data. For example, the second sensor 105 (e.g., an ECG sensor) can be combined with other sensors 105 (e.g., PPG sensor, GSR sensor; etc.) so that a suite of parameter can be sampled concurrently and controlled by the context information of a first set of sensors.

In step 303, the sensor manager 109 then determines resource consumption information associated with a second sensor 105 or group of sensors 105, one or more functions of the second sensor 105, or a combination thereof (step 303). In one embodiment, the one or more functions include, at least in part, data collection, data processing, data transmission, or a combination thereof. Moreover, the resource consumption information relates, at least in part, to energy resources, bandwidth resources, computational resources, memory resources, or a combination thereof.

In one embodiment, the sensor manager 109 may optionally cause, at least in part, a monitoring of the context information, the resource consumption information, or a combination thereof periodically, according to a predetermined schedule, on demand, or a combination thereof (step 305). The sensor manager 109 then processes and/or facilitates a processing of the monitoring, the context information, and/or the resource consumption information to initiate the determination of at least one operational state of the second sensor 105 or one or more functions of the second sensor 105 (step 307). In other words, the sensor manager 109 monitors the context information, the resource consumption information, and/or related updates to trigger a reevaluation of the operational states of the second sensor 105 and/or the one or more functions of the second sensor 105. By way of example, the operational states of the sensors 105 may include setting and/or modifying related operational parameters including sampling rate, parameters to sample, transmission protocol, activity timing, etc. In certain embodiments, the sensor manager 109 can process and/or facilitate a processing of the context information and the resource consumption information to determine a schedule for performing at least one of the one or more functions of the second sensor (step 309).

In step 311, the sensor manager 109 can determine whether the one or more functions relate to one or more interactions of the second sensor 105 with one or more devices (e.g., the UE 101), one or more services (e.g., the service platform 113, the services 115), or a combination thereof. If yes, the sensor manager 109 processes and/or facilitates a processing of the context information and the resource consumption information to determine whether to cause, at least in part, performing of at least one of the one or more functions at the second sensor, the one or more devices, the one or more services, or a combination thereof (step 313).

FIG. 4A is a diagram of a framework for context-aware control of health and wellness sensors, according to one embodiment. As shown, a user 401 is equipped with a wearable sensor system 403 (e.g., a BSN) consisting of three sensors 105a-105c. In this example, the sensors 105b and 105c have connectivity to a sensor 105a which is responsible for collecting and transmitting continuous or substantially continuous monitoring data the UE 101. More specifically, the sensors 105a-105c include at least an accelerometer for determining context information and an ECG sensor 105 which is operated based on the context information according to the various embodiments described herein. The sensors 105a-105c stream the ECG signals to the mobile device for processing, storage, and/or classification.

FIG. 4B is a flowchart of a process for context-aware control of health and wellness sensors, according to one embodiment. In one embodiment, the sensor manager 109 performs the process 420 and is implemented in, for instance, a chip set including a processor and a memory as shown FIG. 9. In addition, the process 420 is performed with respect to the framework of FIG. 4A.

In step 421, the sensor manager 109 receives accelerator sampling data from a first sensor 105a (e.g., an accelerometer). In one embodiment, the accelerometer sampling can be conducted periodically, according to a predetermined schedule, or on demand. In this example, the sampling is conducted with respect to a subject to which the sensor 105a is attached. In step 423, the sensor manager 109 processes and/or facilitates a processing of the accelerometer data to perform activity recognition as described with respect to FIG. 2. In step 425, the sensor manager 109 determines an activity level of the monitored subject based, at least in part, on the activity recognition data (e.g., the context information). If the activity level indicates that the monitored subject is inactive or relatively inactive (e.g., sitting or standing with little to no movement), the sensor manager 109 then determines whether a Bluetooth radio or other short range radio is switched on for connectivity to, for instance, a UE 101 that is to receive the ECG sampling data (step 427). If the Bluetooth radio is not off, the sensor manager 109 causes the radio to be switched on (step 429).

In step 431, the sensor manager 109 initiates ECG sampling by causing a second sensor 105b (e.g., an ECG sensor) to collect ECG sensor data for processing to determine or extract RR or peak intervals (step 433). In one embodiment, the RR interval extraction algorithm adopts, for instance, a modified Pan-Tompkins real-time detection algorithm. By way of example, the algorithm is divided into two phases: (1) noise filtering, and (2) peak detection. In the noise filtering phase, the potential peaks in the ECG data are enhanced and the background baseline drift is attenuated by performing, for instance, a bandpass filter on the raw ECG samples. In one embodiment, the 3 tap bandpass filter is formulated by

y(n)=x(n)−2x(n−1)+x(n−2)

Next, the sensor manager 109 detects the potential peaks by calculating the first derivatives values after bandpass filtered signal formulated by

fd(n)=2y(n)+y(n−2)−y(n−3)−2y(n−4)

In order to remove the negative parts of the derivative values, the first derivative signals are squared.

fd_{squared}(n)=[fd(n)]₂

Then, the algorithm performs a moving average over the squared derivative with 5 samples wide (50 ms). The moving window integration computes the smoothed result that includes the location of candidates and attenuates the random peaks. In one embodiment, the peak detection phase is to find the local maximum for each complex candidate segment.

In step 435, the sensor manager 109 prepares the context information and the extracted features of the processed ECG data (e.g., the RR intervals) for transmission to the UE 101 or the sensor manager 109 operating within the UE 101. For example, the sensor manager 109 prepares the information to be transmitted as data packets. In one embodiment, packet generation can include compressing, encrypting, and the like to further reduce the size of the packet and, therefore, the size of the transmission. The sensor manager 109 then initiates transmission of the packet to the mobile device (e.g., the UE 101) over the short range wireless connection (e.g., Bluetooth connection).

Returning to step 425, if the activity level is high, the sensor manager 109 may conclude that conditions are not favorable for collecting and/or transmitting ECG data to the mobile device. Accordingly, the sensor manager 109 may turn off the short range wireless connection (e.g., Bluetooth) if the radio is on (step 437) and store the packets locally. In addition, the sensor manager 109 can change (e.g., reduce or stop) the sampling rate of the ECG sensor to conserve power during the period of high activity (step 439).

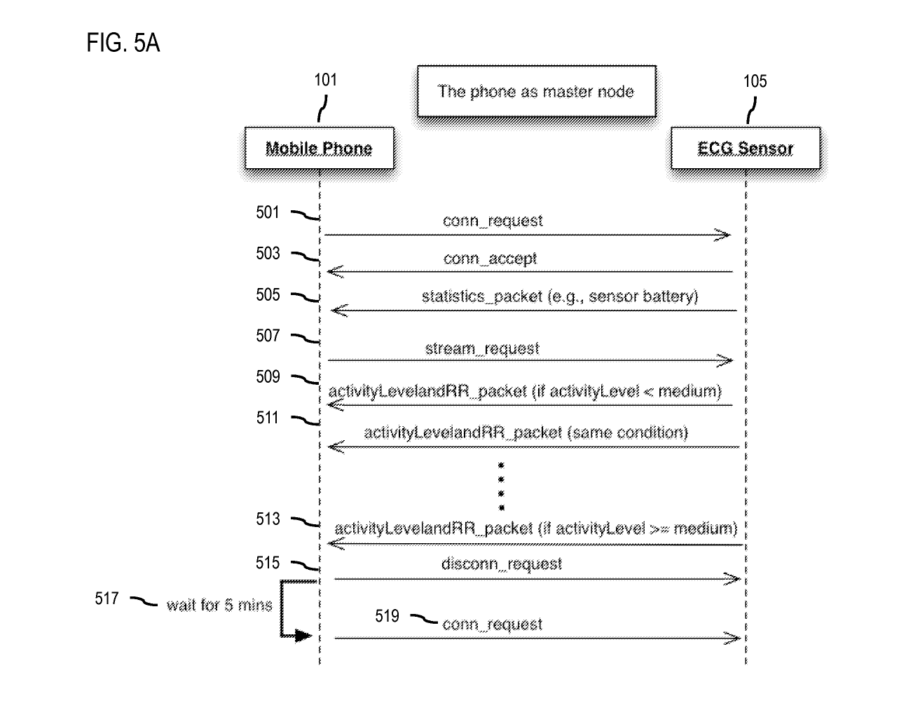

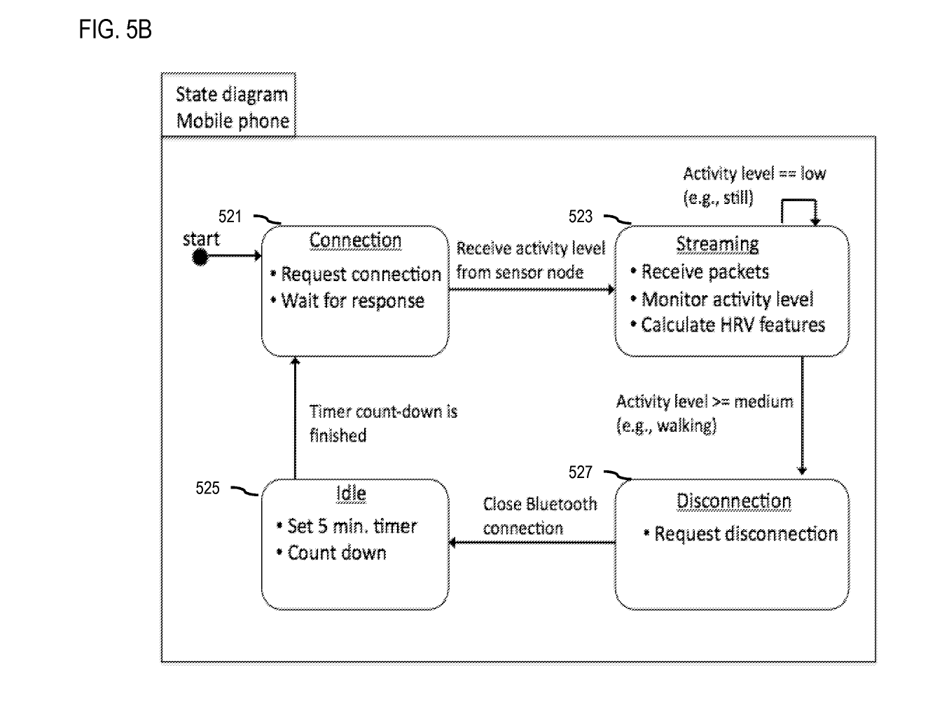

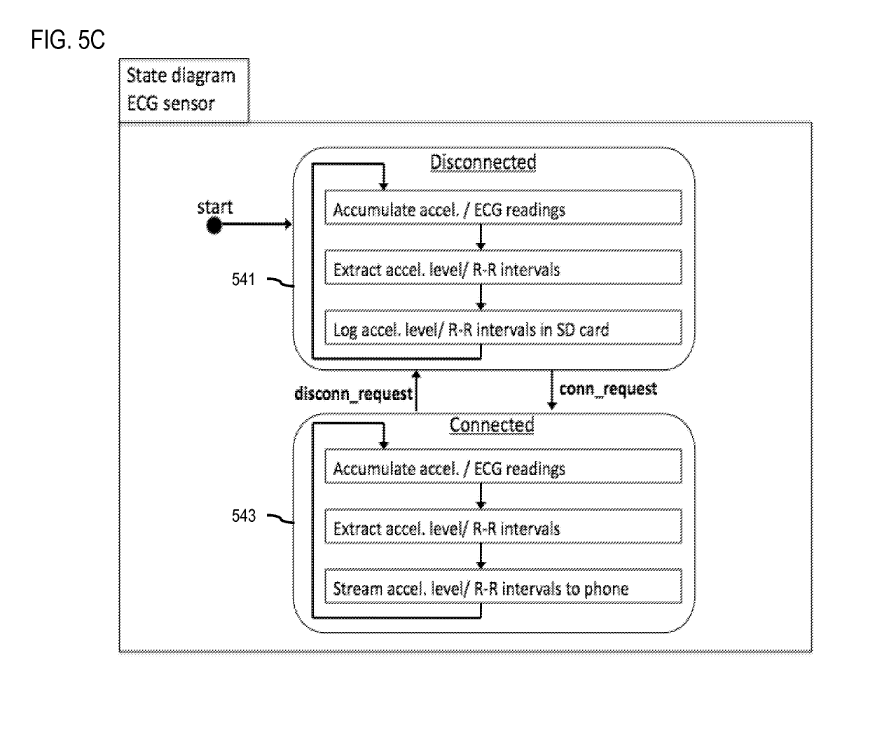

FIGS. 5A-5C are diagrams of a process for context-aware control of sensors and sensor data wherein a device acts as a master of the process, according to various embodiments. FIGS. 5A-5C present a scenario where the UE 101 is acting as a master (e.g., in a Bluetooth Personal Area Network) with respect to communication with a sensor 105. More specifically, FIG. 5A is a time sequence diagram illustrating the communication protocol between the UE 101 and the ECG sensor. At 501, the mobile phone or UE 101 sends a connection request (e.g., a Bluetooth connection request) to the ECG sensor 105. The ECG sensor 105 responds with an acceptance message 503 and also transmits a statistics data package including, for instance, resource consumption and availability information (e.g., sensor battery level) of the ECG sensor 105 (step 505).

In response, the UE 101 sends a request to the ECG sensor 105 to begin streaming context information and sensor data (step 507). At 509, the ECG sensor 105 determines that the activity level of the monitor subject is below a predetermined threshold (e.g., below a medium level), which indicates that the context is favorable for collecting and transmitting the ECG data stream. At 511, the ECG sensor 105 continues to stream the data based on the activity level remaining below the threshold. Alternatively, the ECG sensor 105 can buffer the data and then send the data in batches rather as a continuous stream.

At 513, the ECG sensor 105 detects that the activity level has increased above the predetermined threshold and informs the UE 101. In response, the UE 101 sends a disconnection request to the ECG sensor 105 so that the data streaming and/or data collection can stop until the activity level falls below the threshold (step 515). The UE 101 sets a timer for a predetermined length (e.g., 5 mins) (step 517) before initiating another connection request to resume the ECG data stream (step 519). If the activity level is still above the threshold, the UE 101 resets the timer and waits another 5 mins. Otherwise, the ECG data stream resumes.

FIG. 5B is a state diagram of the mobile device involved in the communication session of FIG. 5A. At 521, the UE 101 enters a connection state by initiating a connection request and waiting for a response. On receiving a response that the activity level is low and conducive for streaming ECG data, the UE 101 enters a streaming state and receives data packets related to the request from the ECG sensor 105 (step 523). In this state, the UE 101 also monitors the activity level of the subject and calculates heart rate variability (HRV) information from the ECG data. When the activity level increases beyond the threshold, the UE 101 enters a disconnection state and sends a request to disconnect from the ECG sensor 105 and closes the connection. At the 525, the UE 101 enters an idle state when waiting for a predetermined timer to expire before attempting another connection.

FIG. 5C is a state diagram of the ECG sensor 105 involved in the communication session of FIG. 5A. In this example, the sensor 105 is a slave to the UE 101. Accordingly, the ECG sensor 105 merely toggles between a disconnected state 541 and a connected state 543. In the disconnected state, the ECG sensor 105 can continue to collect and pre-process data, but does not transmit the data outside of the sensor to save energy. On receiving a connection request from the UE 101, the sensor 105 can toggle to the connected state 543 where it can begin streaming ECG data.

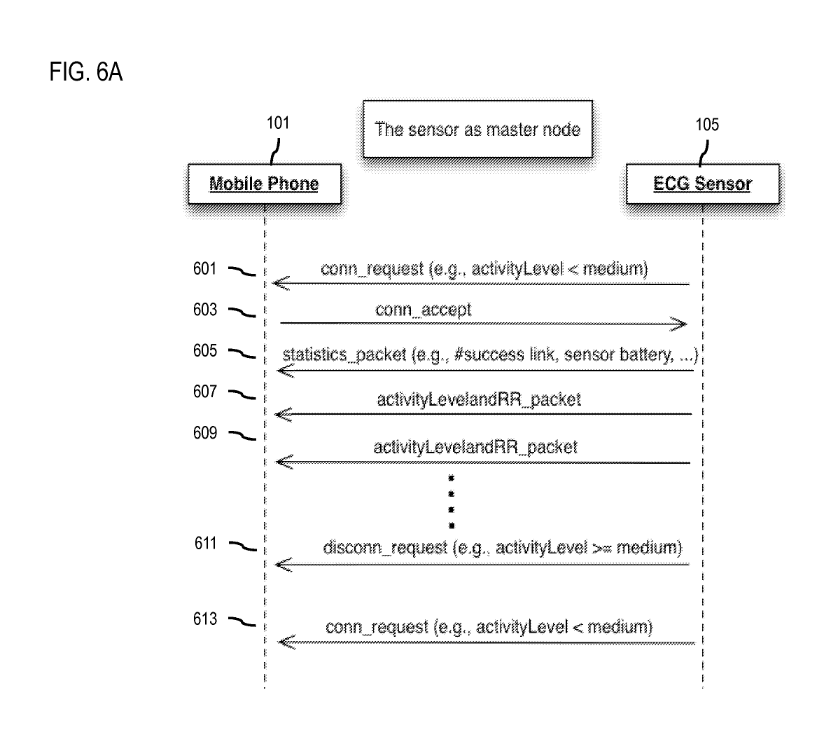

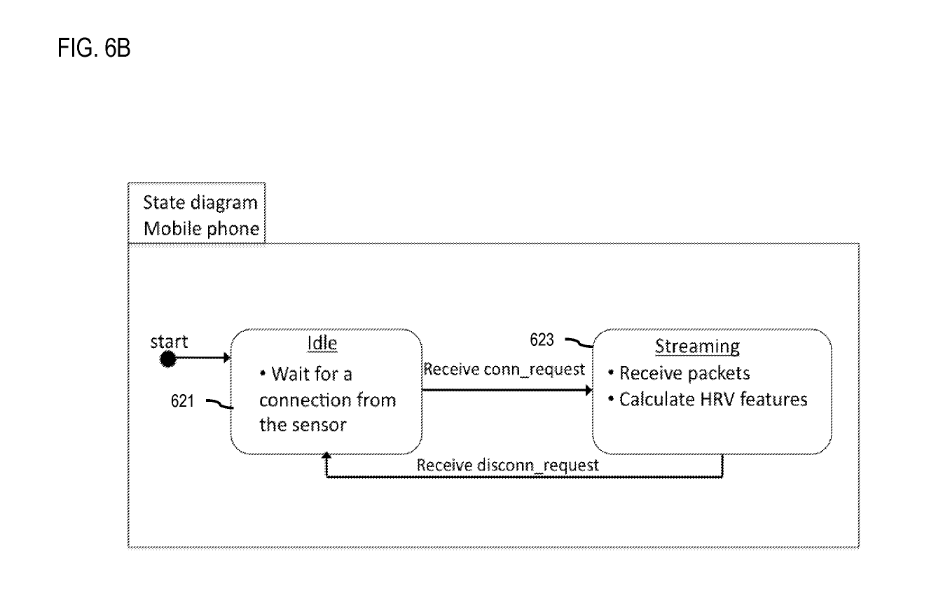

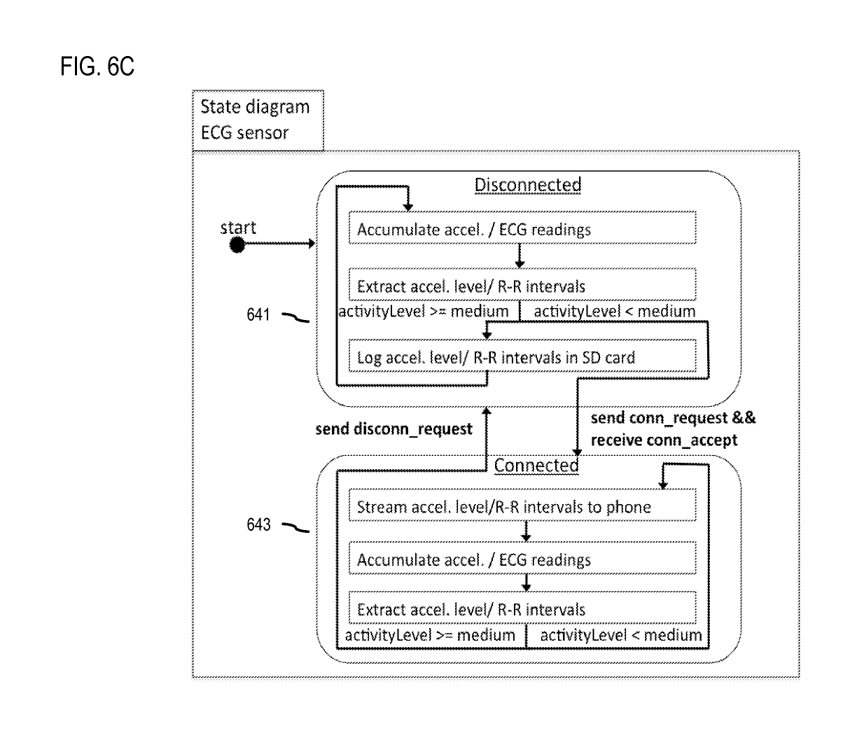

FIGS. 6A-6C are diagrams of a process for context-aware control of sensors and sensor data wherein a device acts as a master of the process, according to various embodiments. The scenario of FIGS. 6A-6C is similar to that presented in FIGS. 5A-5C with the exception that the ECG sensor 105 is acting as a master of the communication session instead of the UE 101. In other words, the sensor 105 controls the wireless connection between it and the UE 101. An advantage of this approach is that the sensor does not need to consume power listening for the incoming connection request from the UE 101. Moreover, the ECG sensor 105 can control the connection depending on its accelerometer or other sensor reading.

FIG. 6A is a time sequence diagram illustrating the communication protocol between the UE 101 and the ECG sensor. At 601, the ECG sensor 105 sends a connection request to the UE 101. The UE 101 accepts the connection (step 603) and the ECG sensor 105 begins by sending statistics packets to the UE 101 (step 605). As discussed above, the statistics packets may contain information about resource consumption or availability as well as statistics on the quality of the connection. At 607 and 609, the ECG sensor 105 begins streaming the ECG data as long as the sensor 105 determines that the activity level of the monitored subject is below a predetermined threshold. At 611, the activity level increases above the threshold and the ECG sensor 103 sends a disconnection request to the UE 101. When the activity level falls below the threshold, the ECG sensor 105 sends a connection request to resume the streaming of the ECG data to the UE 101 (step 613).

FIG. 6B is a state diagram of the mobile device involved in the communication session of FIG. 6A. Because the UE 101 is acting as a slave in this communication session, the UE 101 merely toggles between two states: an idle state 621 and a streamlining state 623. Initially, the UE 101 is in an idle state 621 where it waits and listens for a connection request from the ECG sensor 105. On receiving the connection request, the UE 101 enters a streaming state 623 where it receives ECG data packets for performing HRV calculations. When the ECG sensor disconnects, the UE 101 returns to the idle state 621.

FIG. 6C is a state diagram of the ECG sensor 105 involved in the communication session of FIG. 6A. In this example, the ECG sensor 105 is acting as a master of the communication session. Accordingly, the ECG sensor 105 determines and controls when it toggles between a disconnected state 641 and a connected state 643. The ECG sensor 105 begins in a disconnected state 641. On determining that an activity level of the monitored subject is below the predetermined threshold, the ECG sensor 105 can send a connection request to the UE 101 and begin streaming ECG data to the UE 101. If the activity level increases above the threshold, the ECG sensor 105 sends a disconnection request to the UE 101. The ECG sensor 105 can then monitor the activity level and send a request to resume the connection when the activity level falls below the threshold.

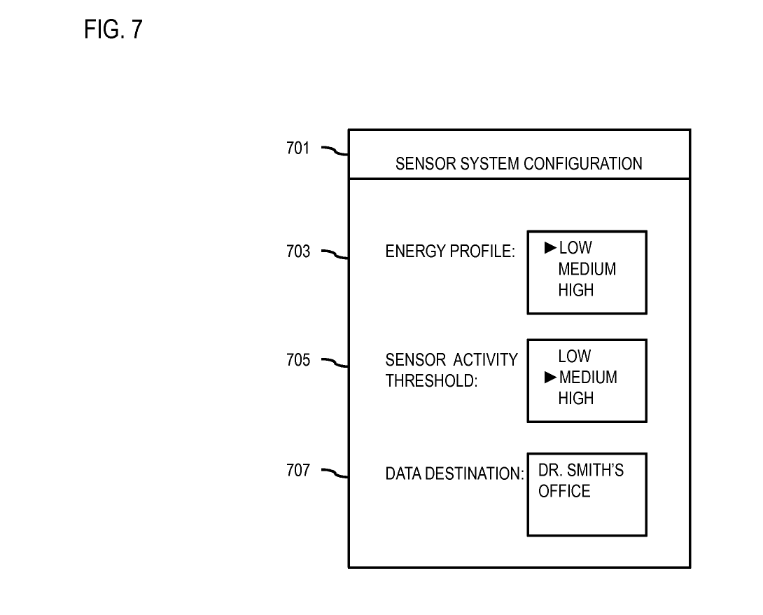

FIG. 7 is a diagram of a user interface utilized in the processes of FIGS. 1-6C, according to one embodiment. FIG. 7 depicts a user interface 701 for configuring the context-aware sensor system. In this example, the user interface 701 provides a control 703 for selecting an energy profile to apply to the sensor 105, the UE 101, and/or the service 115. As show, the energy profile is set to “low” which indicates that the user would like to have the maximum conservation of energy or resource consumption at the sensor 105. For example, the low energy profile can seek to reduce transmissions by increasing the use of batch transmissions, on-node processing, etc.

The user interface 701 also provides a control 705 for setting the sensor activity threshold. In this case, the threshold has been set to medium which allows for more movement of the monitored subject before changing the operational state of the applicable sensor 105. As noted previously, although the threshold values are provided in descriptive terms, it is contemplated that a quantitative metric can also be used to select the threshold.

The user interface 701 also provides a control 707 for selecting the destination of the streamed data. In this example, the user has selected to directly transmit streamed health and wellness data to the user's personal doctor. In one embodiment, the transmission of the data is facilitated by the service platform 113. In other embodiments, the UE 101 receiving the data from the sensor may send the data directly.

The processes described herein for providing context-aware control of sensors and sensor data may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

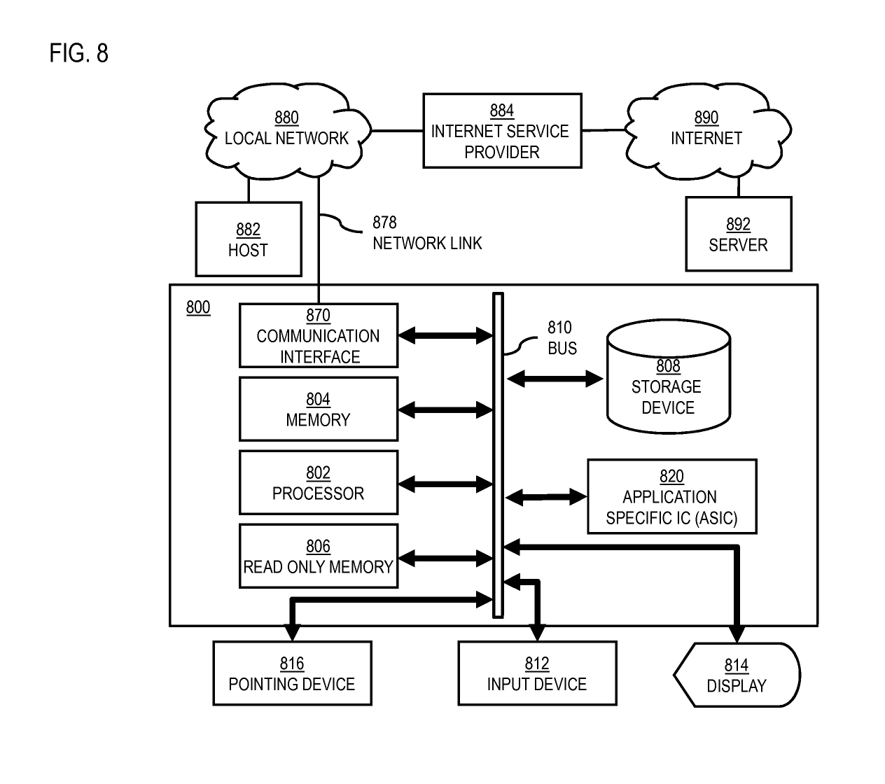

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to provide context-aware control of sensors and sensor data as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of providing context-aware control of sensors and sensor data.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to providing context-aware control of sensors and sensor data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for providing context-aware control of sensors and sensor data. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing context-aware control of sensors and sensor data, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 111 for providing context-aware control of sensors and sensor data.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software; unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to provide context-aware control of sensors and sensor data as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of providing context-aware control of sensors and sensor data.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide context-aware control of sensors and sensor data. The memory 905 also stores the data associated with or generated by the execution of the inventive steps.

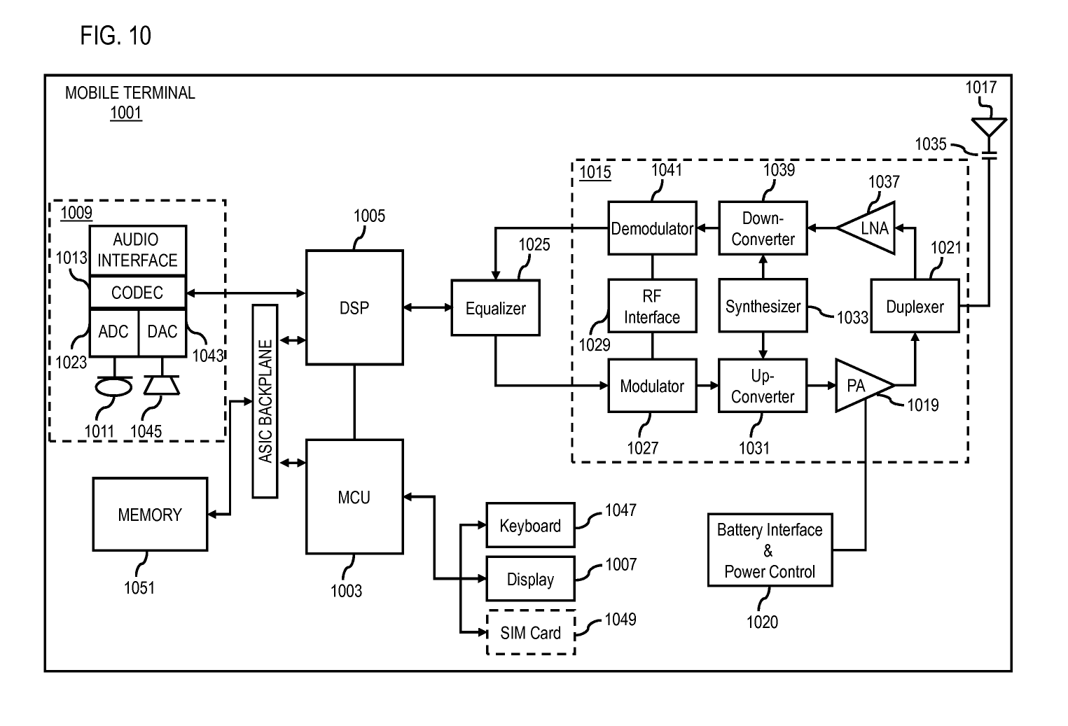

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of providing context-aware control of sensors and sensor data. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of providing context-aware control of sensors and sensor data. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and, converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc. as well as any other suitable wireless medium, e.g., microwave access (WiMAX), Long Term Evolution (LTE) networks, code division multiple access (CDMA), wideband code division multiple access (WCDMA), wireless fidelity (Wi-Fi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to provide context-aware control of sensors and sensor data. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD. ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
context information based, at least in part, on one or more sensors;
resource consumption information associated with one or more other sensors one or more functions of the one or more other sensors, or a combination thereof; and
a processing of the context information and the resource consumption information to determine at least one operational state associated with the one or more other sensors, the one or more functions of the one or more other sensors, or a combination thereof.

2. A method of claim 1, wherein the one or more functions relate to one or more interactions of the one or more other sensors with one or more devices, one or more services, or a combination thereof.

3. A method of claim 2, wherein the (1) data and/or (2) information and/or (3) at least one signal are further based, at least in part, on the following:
a processing of the context information and the resource consumption information to determine whether to cause, at least in part, performing of at least one of the one or more functions at the one or more other sensors, the one or more devices, the one or more services, or a combination thereof.

4. A method of claim 1, wherein the (1) data and/or (2) information and/or (3) at least one signal are further based, at least in part, on the following:
a processing of the context information and the resource consumption information to determine a schedule for performing at least one of the one or more functions of the one or more other sensors.

5. A method of claim 1, wherein the (1) data and/or (2) information and/or (3) at least one signal are further based, at least in part, on the following:
a monitoring of the context information, the resource consumption information, or a combination thereof periodically, according to a predetermined schedule, on demand, or a combination thereof; and
a processing of the monitoring to initiate the determination of the at least one operational state.

6. A method of claim 1, wherein the context information is further based, at least in part, on at least a third sensor.

7. A method of claim 1, wherein the resource consumption information relate, at least in part, to energy resources, bandwidth resources, computational resources, memory resources, or a combination thereof.

8. A method of claim 1, wherein the one or more functions include, at least in part, data collection, data processing, data transmission, or a combination thereof.

9. A method of claim 1, wherein the one or more other sensors include wearable health or wellness sensors.

10. A method of claim 1, wherein the one or more other sensors are affected by movement, and the one or more sensors detects at least one movement or one or more characteristics of the at least one movement of the one or more other sensors.

11. An apparatus comprising:
at least one processor; and
at least one memory including computer program code,
the at least one memory and the computer program code configured to, with the at least one processor, cause the apparatus to perform at least the following,
determine context information based, at least in part, on one or more sensors;
determine resource consumption information associated with a one or more other sensors, one or more functions of the one or more other sensors, or a combination thereof; and
process and/or facilitate a processing of the context information and the resource consumption information to determine at least one operational state associated with the one or more other sensors, the one or more functions of the one or more other sensors, or a combination thereof.

12. An apparatus of claim 11, wherein the one or more functions relate to one or more interactions of the one or more other sensors with one or more devices, one or more services, or a combination thereof.

13. An apparatus of claim 12, wherein the apparatus is further caused to:
process and/or facilitate a processing of the context information and the resource consumption information to determine whether to cause, at least in part, performing of at least one of the one or more functions at the one or more other sensors, the one or more devices, the one or more services, or a combination thereof.

14. An apparatus of claim 11, wherein the apparatus is further caused to:
process and/or facilitate a processing of the context information and the resource consumption information to determine a schedule for performing at least one of the one or more functions of the one or more other sensors.

15. An apparatus of claim 11, wherein the apparatus is further caused to:
cause, at least in part, a monitoring of the context information, the resource consumption information, or a combination thereof periodically, according to a predetermined schedule, on demand, or a combination thereof; and
process and/or facilitate a processing of the monitoring to initiate the determination of the at least one operational state.

16. An apparatus of claim 11, wherein the context information is further based, at least in part, on at least a third sensor.

17. An apparatus of claim 11, wherein the resource consumption information relate, at least in part, to energy resources, bandwidth resources, computational resources, memory resources, or a combination thereof.

18. An apparatus of claim 11, wherein the one or more other sensors include wearable health or wellness sensors.

19. A computer-readable storage medium carrying one or more sequences of one or more instructions which, when executed by one or more processors, cause an apparatus to perform at least:
determining context information based, at least in part, on one or more sensors;
determining resource consumption information associated with a one or more other sensors, one or more functions of the one or more other sensors, or a combination thereof; and
processing and/or facilitating a processing of the context information and the resource consumption information to determine at least one operational state associated with the one or more other sensors, the one or more functions of the one or more other sensors, or a combination thereof.

20. A computer-readable storage medium of claim 19, wherein the one or more functions relate to one or more interactions of the one or more other sensors with one or more devices, one or more services, or a combination thereof, and wherein the apparatus is caused to further perform:
processing and/or facilitating a processing of the context information and the resource consumption information to determine whether to cause, at least in part, performing of at least one of the one or more functions at the one or more other sensors, the one or more devices, the one or more services, or a combination thereof.

21.-48. (canceled)
